(19) United States
(12) Patent Application Publication
(10) Pub. No.: US 2008/0025540 A1
(43) Pub. Date: Jan. 31, 2008

(54) Hearing device system with a receptacle for a control element

(76) Inventor: Harald Klemenz, Singapore (SG)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/881,695

(22) Filed: Jul. 27, 2007

(30) Foreign Application Priority Data
Jul. 28, 2006 (DE) 10 2006 035 090.1

(51) Int. Cl. H04R 25/00

(52) U.S. Cl. 381/324

(57) ABSTRACT

To enable the manufacturing of a hearing device system to be simplified, the inventive hearing device system comprises a housing with a housing element which features a receptacle for a control element, with the receptacle being embodied in such a way that a movable part of the control element is able to be fitted directly into the receptacle without a further housing which encloses the control element or the control element parts having to be provided.

### CROSS REFERENCE TO RELATED APPLICATIONS

This application claims priority of German application No. 10 2006 035 090.1 filed Jul. 28, 2006, which is incorporated by reference herein in its entirety.

### FIELD OF THE INVENTION

The invention relates to a hearing device system, featuring a housing with at least one housing element comprising at least one receptacle for a control element, and also to a method for manufacturing said system.

### BACKGROUND OF THE INVENTION

As a result of efforts to miniaturize hearing devices, the space available on the housing of a hearing device for accommodating control elements is severely restricted. This is especially true of in-the-ear (ITE) hearing devices.

When hearing devices are manufactured, control elements, e.g. keyswitches or rotary switches, are installed as a separate component. In such cases the control elements are frequently bought in as separate components from OEMs, receptacles in the form of openings for example are provided in the housing and the component is glued-in or inserted using mechanical connections. The component provided as a separate control element has a housing of its own in such cases which surrounds the control element and with which it is inserted into the receptacle of the hearing device housing. This increases the overall space required by the control element.

### SUMMARY OF THE INVENTION

The object of the present invention is to create a hearing device system in which the space required by the control elements is especially small and for which the manufacturing process is made easier.

Inventively this is achieved by a hearing device system as well as by a manufacturing method as claimed in the claims. Preferred developments of the invention are contained in the dependent material claims.

The inventive hearing device system comprises a housing with at least one housing element, which features at least one receptacle for a control element, with the receptacle being embodied so that a movable part of the control element is able to be fitted directly into the receptacle.

Within the context of the present invention the term “able to be fitted directly” means that a control element or a combination of a number of control element parts can be fitted directly into the receptacle provided for the purpose in the housing element and can be secured there, without a further housing which encloses the control element or control element parts being necessary and having to be fitted into the receptacle. A “movable part” can be a part which is moved when the control element is operated.

The receptacle can be embodied as a recess or opening in the housing element.

Preferably the inventive hearing device system includes an in-the-ear (ITE) hearing device. The inventive housing element preferably involves a housing plate or a cover plate of an ITE, known as the faceplate, which is accessible from the outside when the ITE is being worn.

The control element can comprise a pushbutton or a rotary switch. It can also include other switches, e.g. sliders, combination rotary and pushbutton switches, etc.

A movable part of the control element is fitted directly into the receptacle of the housing element such that it can move within the housing element for example. With a pushbutton or a slider switch the movable part can for example be moved within the receptacle provided for it in the housing element, with a rotary switch the movable part can for example be rotated in the receptacle provided for it in the housing element.

Usually the control elements are either directly connected to a circuit board in the hearing device or are mounted on this board or are electrically connected via litz wires or wires to a circuit board.

In accordance with a preferred aspect of the present invention conductor tracks are arranged on the housing element so as to interact functionally with the control element. The conductor tracks can be for example be accommodated on the inner side of the housing element. This enables the control element to be fitted into the housing element in a single operation and functionally connected electrically. This makes low-cost manufacturing possible since an additional operational step of connecting the control element to a conductor track is not necessary. A further space saving is also able to be implemented in this way.

In accordance with a further aspect of the present invention the operating element is accommodated in the receptacle using a non-positive-fit connection or a positive-fit connection. For example the operating element can be fitted into the receptacle using a snap-in or clip connection.

The control element can now be fitted directly into the housing element during manufacturing. Embodying the control elements in a modular manner (i.e. identical dimensions for different control elements) makes it possible to simplify manufacturing further.

### BRIEF DESCRIPTION OF THE DRAWINGS

Further advantages and features will become clear by reference to the exemplary embodiment and the appended drawings, which show:

FIG. 1 a schematic diagram of a housing element with a control element fitted into it in accordance with the prior art; and

FIG. 2 a schematic diagram of a housing element with a control element fitted into it in accordance with the present invention.

### DETAILED DESCRIPTION OF THE INVENTION

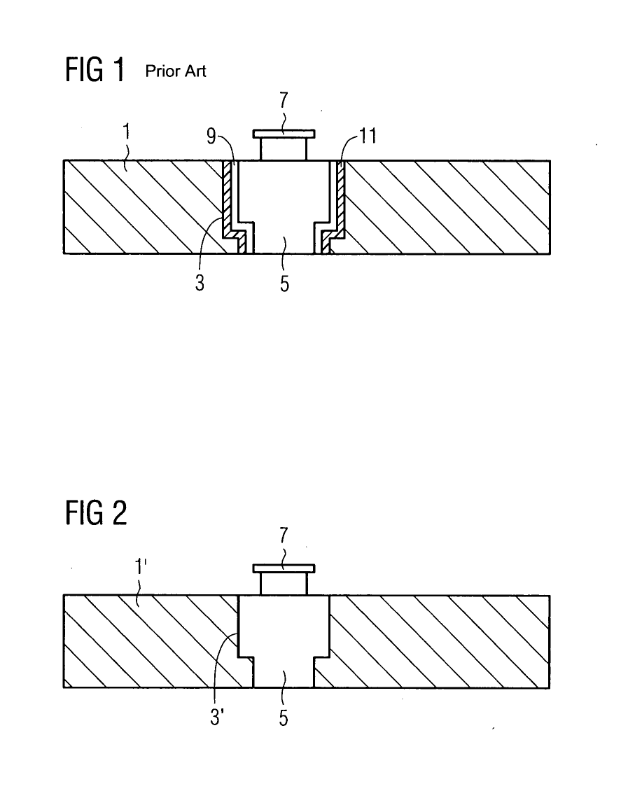

In FIG. 1 a housing element 1 features a receptacle 3 embodied as a cylindrical cavity or opening, into which a control element 5 is fitted. The control element 5 is a pushbutton switch with button 7 and a housing 9 enclosing the control element. The housing 9 is held in the receptacle 3 by an adhesive bond 11.

FIG. 2 shows an inventive arrangement with housing element 1′, receptacle 3′ for a control element 5 with pushbutton switch 7. The control element 5 is accommodated directly in the housing element 1′ in the receptacle 3′ by a snap-in connection without the need for a further housing for the control element or a layer of adhesive. Moving parts can move directly in the receptacle 3′, e.g. shift, rotate, etc. It is evident that the inventive arrangement comprising control element and housing element saves more space and that constructing the inventive arrangement requires fewer expensive operating steps.

In this way a movable part of the control element can be accommodated directly in the receptacle, without a further housing which encloses the control element or the control element parts having to be provided.

1.-8. (canceled)

9. A hearing device system, comprising:
a control element; and
a receptacle on a housing element that is configured to directly fit a movable part of the control element into the receptacle.

10. The hearing device system as claimed in claim 9, wherein the hearing device system is an in-the-ear hearing device.

11. The hearing device system as claimed in claim 10, wherein the housing element is a cover plate that is accessible from an outside when the in-the-ear hearing device is worn by a user.

12. The hearing device system as claimed in claim 9, wherein the control element is a pushbutton switch.

13. The hearing device system as claimed in claim 9, wherein the control element is a rotary switch.

14. The hearing device system as claimed in claim 9, wherein the housing element comprises a conductor track that functionally interacts with the control element.

15. The hearing device system as claimed in claim 9, wherein the control element is accommodated in the receptacle by a non-positive-fit connection or a positive-fit connection.

16. A method for manufacturing a hearing device system, comprising:
manufacturing a housing element comprising a receptacle; and
directly fitting a movable part of a control element of the hearing device system into the receptacle.

17. The method as claimed in claim 16, wherein the hearing device system is an in-the-ear hearing device.

18. The method as claimed in claim 17, wherein the housing element is a cover plate that is accessible from an outside when the in-the-ear hearing device is worn by a user.

19. The method as claimed in claim 16, wherein the control element is a pushbutton switch.

20. The method as claimed in claim 16, wherein the control element is a rotary switch.

21. The method as claimed in claim 16, wherein the housing element comprises a conductor track that functionally interacts with the control element.

22. The method as claimed in claim 16, wherein the control element is accommodated in the receptacle by a non-positive-fit connection or a positive-fit connection.
